(19) United States
(12) Patent Application Publication
(10) Pub. No.: US 2007/0262691 A1
(43) Pub. Date: Nov. 15, 2007

(54) Color cathode-ray tube apparatus

(75) Inventors: Koichi Matsumoto, Mino-shi (JP); Kenichiro Taniwa, Takatsuki-shi (JP)

Correspondence Address: HAMRE, SCHUMANN, MUELLER & LARSON, P.C., P.O. BOX 2902, MINNEAPOLIS, MN, 55402-0902, US

(73) Assignee: MT Picture Display Co., Ltd., Takatsuki-shi (JP)

(21) Appl. No.: 11/801,267

(22) Filed: May 9, 2007

(30) Foreign Application Priority Data
May 11, 2006 (JP) 2006-132461

(51) Int. Cl. H01J 29/46

(52) U.S. Cl. 313/442

(57) ABSTRACT

A pair of upper and lower magnetic field generators TG, BG are disposed in the vicinity of the end of a deflection device 30 on a phosphor screen 14 side so as to sandwich a horizontal plane. A pair of upper and lower coma aberration correction coil systems 60 in each of which a coil is wound around a substantially U-shaped core are disposed on an electron gun 16 side from a vertical deflection coil 34 so as to sandwich the horizontal plane. A pair of upper and lower magnetic members 70 are disposed between the vertical deflection coil 34 and a separator 38 so as to sandwich the horizontal plane. The angle θc defined by inner tips of two legs of the substantially U-shaped core and a tube axis viewed along the tube axis satisfies 10°≦θc≦42°. This makes it possible with a simple configuration and at low cost to correct coma aberration, misconvergence, and pincushion raster distortion in upper, lower, left and right portions of a screen, and to prevent cropping or clipping of images on the screen due to occurrence of BSN.

### BACKGROUND OF THE INVENTION

1. Field of the Invention

The present invention relates to a color cathode-ray tube apparatus used for a TV, a monitor, or the like.

2. Description of Related Art

Nowadays, a so-called self-convergence in-line color cathode-ray tube apparatus is in wide use. This color cathode-ray tube apparatus includes an in-line electron gun for emitting three aligned electron beams including a center electron beam and a pair of side electron beams on both sides of the center electron beam that pass in the same horizontal plane, a deflection device including a horizontal deflection coil for generating a pincushion horizontal deflection magnetic field and a vertical deflection coil for generating a barrel vertical deflection magnetic field, at least a pair of upper and lower permanent magnets provided at an edge of a screen-side opening of the deflection device for fine-tuning these horizontal and vertical deflection magnetic fields and a pair of auxiliary coil systems provided at the end of the deflection device on the electron gun side for correcting coma aberration. In this color cathode-ray tube apparatus, the three electron beams are converged over an entire screen, and the electron gun and the deflection device are combined so that deflection distortion (raster distortion) in upper and lower portions, or upper, lower, right and left portions, of the screen is corrected to be substantially straight.

Conventionally, suggestions have been made to provide a deflection device with various auxiliary magnetic field generation devices, thereby enhancing convergence performance and raster distortion performance.

For example, JP2001-196012A describes that misconvergence is corrected by using auxiliary coil systems formed by winding, around a substantially U-shaped ferrite core, a coma aberration correction coil and a correction coil to which a diode-rectified current is supplied.

JP61(1986)-253750A and JP6(1994)-295158A disclose that coma aberration, trilemma, and pincushion distortion of rasters in upper, lower, left and right portions of a screen are corrected by controlling magnetic fields generated from both side legs and the center leg of an E-shaped core of an auxiliary coil system, and that misconvergence is corrected readily by using an auxiliary coil system including an E-shaped core and an auxiliary coil system including a U-shaped core in combination.

Furthermore, JP56(1981)-9950A, JP58(1983)-71967U, JP54(1979)-168125U and JP54(1979)-47421A disclose that a desired distortion distribution of a vertical deflection magnetic field in a tube-axis direction is formed by adjusting the wire distribution of a vertical deflection coil, disposing a pair of magnetic members between the vertical deflection coil and a separator, and disposing a pair of magnetic field generators in upper and lower portions at the end of a deflection device on the phosphor screen side, thereby correcting convergence and the pincushion distortion of rasters in upper, lower, left and right portions of a screen.

Recently, the demand for high image quality and low cost is increasing year after year with respect to a television device using a color cathode-ray tube apparatus. Therefore, in terms of cost, it is becoming difficult to mount an additional expensive or complicated auxiliary magnetic field generation device to enhance image quality.

With the above-described auxiliary coil system disclosed in JP2001-196012A, the ferrite core has a U-shape, instead of an E-shape, so that it is possible to correct coma aberration (VCR) and misconvergence at a lower cost. However, there is the problem that pincushion distortion of rasters in left and right portions of the screen is increased, and remains.

With the auxiliary coil systems disclosed in JP61(1986)-253750A and JP6(1994)-295158A, although it is possible to correct coma aberration and misconvergence such as trilemma, there is the problem that the use of an E-shaped core, which is more complex than a U-shaped core, increases the number of manufacturing steps, thus increasing the cost.

With the configurations disclosed in JP56(1981)-9950A, JP58(1983)-71967U, JP54(1979)-168125U and JP54(1979)-47421A, although it is possible to correct pincushion distortion of rasters in upper, lower, left and right portions of the screen and misconvergence, there is the problem that coma aberration cannot be corrected sufficiently.

Therefore, it might seem that coma aberration, misconvergence, and pincushion distortion of rasters in upper, lower, left and right portions of a screen could be corrected at low cost by combining the configuration disclosed in JP2001-196012A, and the configurations disclosed in JP56(1981)-9950A, JP58(1983)-71967U, JP54(1979)-168125U and JP54(1979)-47421A, that is, by providing auxiliary coil systems including a U-shaped core, disposing a pair of magnetic members between a vertical deflection coil and a separator, adjusting the wire distribution of the vertical deflection coil, and disposing a pair of magnetic field generators in upper and lower portions at the end of a deflection device on the phosphor screen side.

However, when coma aberration, misconvergence, and pincushion distortion of raters in upper, lower, left and right portions of a screen are corrected by using a conventional vertical deflection coil, an auxiliary coil system including a U-shaped core, a pair of magnetic members disposed between a vertical deflection coil and a separator, and a pair of upper and lower magnetic field generators disposed at the end of a deflection device on the phosphor screen side, there has been the problem that especially side electron beams that are included in three electron beams aligned in a horizontal direction strike the inner surface of a funnel and hence do not reach the phosphor screen, resulting in the phenomenon (Beam Strike to Neck, hereinafter, referred to as “BSN”) that there is cropping or clipping of images, especially at a corner portion of the screen. This is due to the following reason. A coma aberration correction magnetic field generated by the auxiliary coil-system including a U-shaped core has the same polarity as that of a vertical deflection magnetic field generated by the vertical deflection coil, so that the amount of the vertical deflection of the three electron beams is increased at the electron gun side of the funnel. Accordingly, the distance between the track of the side electron beam and the inner surface of the funnel is decreased, especially when the three electron beams are deflected to the corner portion of the screen.

### SUMMARY OF THE INVENTION

The present invention was achieved in order to solve the above-described problems in conventional color cathode-ray tube apparatuses, and it is an object of the invention to provide a color cathode-ray tube apparatus capable of correcting coma aberration, misconvergence, and pincushion distortion of rasters in upper, lower, left and right portions of a screen with a simple configuration and at low cost, without using a complex and expensive auxiliary magnetic field generation device such as an auxiliary coil system including an E-shaped core, and also realizing good image quality free from cropping or clipping of images on the screen due to occurrence of BSN at low cost.

A color cathode-ray tube apparatus according to the present invention includes: a color cathode-ray tube having an electron gun for emitting three electron beams aligned in a horizontal direction and a phosphor screen for emitting light when struck by the three electron beams emitted from the electron gun; and a deflection device having a horizontal deflection coil for generating a horizontal deflection magnetic field that deflects the three electron beams in the horizontal direction, a vertical deflection coil for generating a vertical deflection magnetic field that deflects the three electron beams in a vertical direction, a ferrite core for enhancing a magnetic efficiency of the horizontal deflection coil and the vertical deflection coil, and a separator placed outside of the horizontal deflection coil and inside of the vertical deflection coil and the ferrite core.

At least a pair of magnetic field generators are disposed in the vicinity of an end of the deflection device on the phosphor screen side with a horizontal plane, which includes a horizontal axis and a tube axis, being interposed therebetween. The at least pair of magnetic field generators include a first magnetic field generator disposed on an upper side from the horizontal plane for generating a magnetic field of the same polarity as that of a magnetic field generated by the vertical deflection coil when the three electron beams are deflected upward, and a second magnetic field generator disposed on a lower side from the horizontal plane for generating a magnetic field of the same polarity as that of a magnetic field generated by the vertical deflection coil when the three electron beams are deflected downward.

A pair of coma aberration correction coil systems in each of which a coil is wound around a substantially U-shaped core are disposed on the electron gun side from the vertical deflection coil in a tube-axis direction with the horizontal plane being interposed therebetween so as to be symmetrical with respect to the tube axis.

A pair of magnetic members are disposed between the vertical deflection coil and the separator with the horizontal plane being interposed therebetween so as to be symmetrical with respect to the tube axis.

An angle θc defined by inner tips of two legs of the substantially U-shaped core and the tube axis viewed along the tube axis satisfies 10°≦θc≦42°.

### BRIEF DESCRIPTION OF THE DRAWINGS

FIG. 1 is a half cross-sectional view showing a schematic configuration of a color cathode-ray tube apparatus according to one embodiment of the present invention.

FIG. 2 is a view showing a horizontal deflection magnetic field generated by a horizontal deflection coil at a certain moment in the color cathode-ray tube apparatus according to one embodiment of the present invention.

FIG. 3 is a view showing a vertical deflection magnetic field generated by a vertical deflection coil at a certain moment in the color cathode-ray tube apparatus according to one embodiment of the present invention.

FIG. 4 is a view showing a pair of coma aberration correction coil systems seen from the phosphor screen side and a vertical deflection magnetic field generated by the pair of coma aberration correction coil systems in the color cathode-ray tube apparatus according to one embodiment of the present invention.

FIG. 5A is a front view showing the arrangement of magnetic poles of a pair of permanent magnets seen from a phosphor screen side in the color cathode-ray tube apparatus according to one embodiment of the present invention, and FIG. 5B is a view showing the action on rasters in upper and lower portions of a quadrupole magnetic field generated by the pair of permanent magnets.

FIG. 6 is a view showing coma aberration (VCR) generated in upper and lower portion of a screen of the color cathode-ray tube apparatus.

FIG. 7 is a conceptual diagram showing vectors of force that the center electron beam traveling toward a corner portion of the screen receives from a pincushion horizontal deflection magnetic field when there is a preliminary vertical deflection magnetic field and when there is no preliminary vertical deflection magnetic field.

FIG. 8 is a perspective view showing occurrence of BSN.

FIG. 9 is a view showing a pair of coma aberration correction coil systems including an E-shaped core seen from the phosphor screen side and a magnetic field generated by the pair of coma aberration correction coil systems.

FIG. 10A is a view showing the vertical deflection magnetic field changed by a pair of magnetic members and vectors of force acting on the three electron beams in the color cathode-ray tube apparatus according to one embodiment of the present invention, and FIG. 10B is a view showing the magnetic flux density distribution of the strength of the vertical deflection magnetic field along the X-axis in FIG. 10A.

FIG. 11 is a view showing the dimensions of various parts of the pair of coma aberration correction coil systems in the color cathode-ray tube apparatus according to one embodiment of the present invention.

FIG. 12 is a graph showing a relationship between the angle θc of a pair of correction coil systems including a substantially U-shaped core and the coma aberration correction amount.

FIG. 13 is a graph showing a relationship between the angle θc of the pair of correction coil systems including a substantially U-shaped core and the YBP amount at which BSN starts to occur.

FIG. 14 is a view showing a method for measuring the magnetic force of a permanent magnet.

FIG. 15 is a view showing YH misconvergence generated on the screen of the color cathode-ray tube apparatus.

### DETAILED DESCRIPTION OF THE INVENTION

According to the present invention, it is possible to correct coma aberration, misconvergence, and pincushion distortion of rasters in upper, lower, left and right portions of a screen by using a simple and low-cost configuration that uses coma aberration correction coil systems including a U-shaped core, without using any coma aberration correction coil system including an E-shaped core for generating a magnetic field of a polarity opposite to that of a vertical deflection magnetic field, and also to reduce cropping or chipping of images on the screen due to occurrence of BSN.

Hereinafter, a color cathode-ray tube apparatus according to one embodiment of the present invention will be described with reference to the drawings.

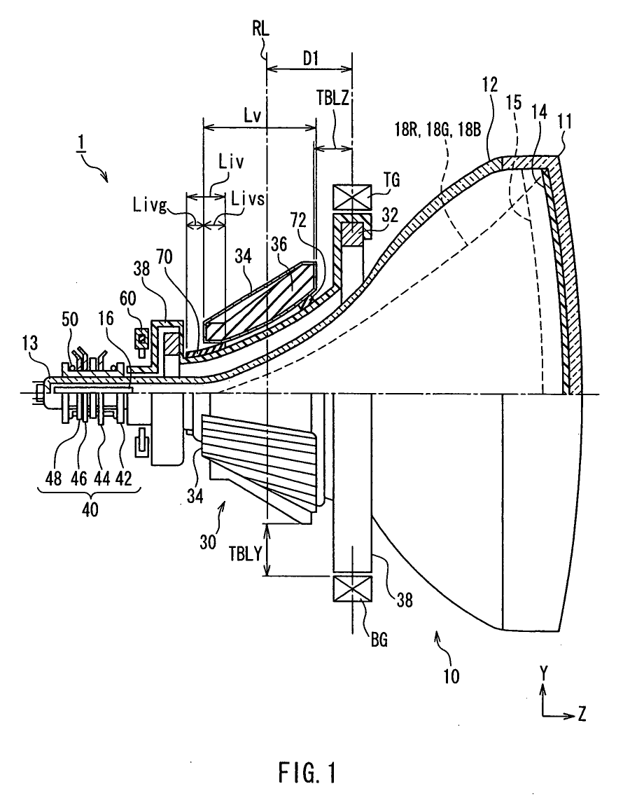

FIG. 1 is a half cross-sectional view showing a schematic configuration of the color cathode-ray tube apparatus according to one embodiment of the present invention. For convenience of the following description, it is assumed that a tube axis is a Z-axis, a horizontal (screen long-side direction) axis is an X-axis, and a vertical (screen short-side direction) axis is a Y-axis. The X-axis and the Y-axis cross each other at right angles on the Z-axis. In FIG. 1, a cross-sectional view is shown on an upper side from the Z-axis, and the outer appearance view is shown on a lower side therefrom.

As shown in FIG. 1, a color cathode-ray tube apparatus 1 includes a color cathode-ray tube 10, a deflection device 30, a convergence purity unit (CPU) 40, and a velocity modulation coil 50, for example.

The color cathode-ray tube 10 includes a glass bulb formed by joining a face panel 11 and a funnel 12 together, and a shadow mask 15 and an in-line electron gun (hereinafter, simply referred to as an “electron gun”) 16 that are contained in the glass bulb).

An inner surface of the face panel 11 is provided with a substantially rectangular phosphor screen 14 formed by arranging respective phosphor dots (or phosphor stripes) of red, green, and blue in a regular manner. The shadow mask 15 is provided at a substantially constant distance from the phosphor screen 14. The shadow mask 15 is provided with a number of dot-shaped or slot-shaped electron beam passage apertures. Three electron beams 18R, 18G, 18B (three electron beams are arranged in a straight line parallel to the X-axis, so that only one electron beam on the front side is shown in the figure) emitted from the electron gun 16 pass through the electron beam passage apertures provided in the shadow mask 15, and the desired phosphors are irradiated with these electron beams.

The electron gun 16 is provided inside a neck 13 of the funnel 12. The electron gun 16 emits three electron beams that are in-line aligned on the horizontal axis (X-axis), namely, a center electron beam 18G placed at the center, and a pair of side electron beams 18R, 18B arranged on both sides in the X-axis direction with respect to the center electron beam 18G toward the phosphor screen 14.

The deflection device 30 is provided on an outer circumferential surface of a portion of the funnel 12, extending from a large-diameter portion to the neck 13. The deflection device 30 is a saddle-toroidal deflection device including a saddle-type horizontal deflection coil 32 and a toroidal vertical deflection coil 34 as its main deflection coils. The vertical deflection coil 34 is wound around a ferrite core (hereinafter, simply referred to as a “core”) 36. The core 36 has a substantially funnel shape with a large-diameter portion on the phosphor screen 14 side and a small-diameter portion on the electron gun 16 side, and enhances the magnetic efficiency of a vertical deflection magnetic field generated by the vertical deflection coil 34 and a horizontal deflection magnetic field generated by the horizontal deflection coil 32. A resin frame (separator) 38 is provided between the vertical deflection coil 34 and the core 36, and the horizontal deflection coil 32 that is placed on the funnel 12 side (inner side) relative to the vertical deflection coil 34 and the core 36. The resin frame 38 maintains an electrical insulated state between the horizontal deflection coil 32 and the vertical deflection coil 34, and supports the two deflection coils 32, 34.

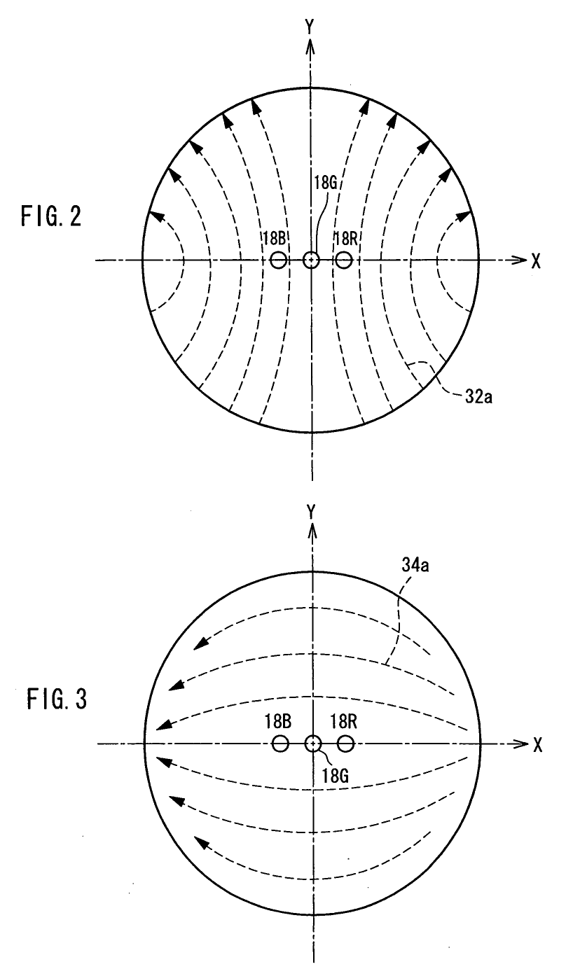

The horizontal deflection coil 32 generates a pincushion horizontal deflection magnetic field 32a as represented by a broken line in FIG. 2, and the vertical deflection coil 34 generates a barrel vertical deflection magnetic field 34a as represented by a broken line in FIG. 3.

The CPU 40 is provided on an outer circumferential surface of the neck 13 at a position overlapping the electron gun 16 in the Z-axis direction, and performs static convergence adjustment and purity adjustment of the three electron beams 18R, 18G, 18B in a center portion of the screen. The CPU 40 includes a purity (color purity) magnet 44, a quadrupole magnet 46, and a hexapole magnet 48 that are attached to a cylindrical resin frame 42. The purity magnet 44, the quadrupole magnet 46, and the hexapole magnet 48 are each formed of a set of two annular magnets.

The velocity modulation coil 50 is formed of a pair of loop coils that are disposed on both sides so as to sandwich a plane (an XZ-plane, i.e., a horizontal plane) including the X-axis and the Z-axis. The pair of loop coils are attached to the resin frame 42 of the CPU 40 so as to be substantially symmetrical with respect to the Z-axis. The pair of loop coils are supplied with a current in accordance with a velocity modulation signal obtained by differentiating a video signal. The velocity modulation coil 50 generates a vertical magnetic field so as to modulate a horizontal scanning velocity of the electron beams, thereby performing an edge enhancement for an image.

The deflection device 30 includes a pair of permanent magnets (magnetic field generators) TG, BG in the vicinity of its end on the phosphor screen 14 side. The pair of permanent magnets TG, BG are disposed across a plane (a YZ-plane, a vertical plane) including the Y-axis and the Z-axis so as to sandwich a plane (an XZ-plane, a horizontal plane) including the X-axis and the Z-axis. As shown in FIG. 1, it is preferable that, in the Y-axis direction, the pair of permanent magnets TG, BG are placed away from the core 36 on a side opposite to the Z-axis with respect to an outermost peripheral edge of the core 36 on the large-diameter side. Furthermore, it is preferable that, in the Z-axis direction, the center of the pair of permanent magnets TG, BG is placed at the same position as that of the end of the core 36 on the large-diameter side or on the phosphor screen 14 side therefrom.

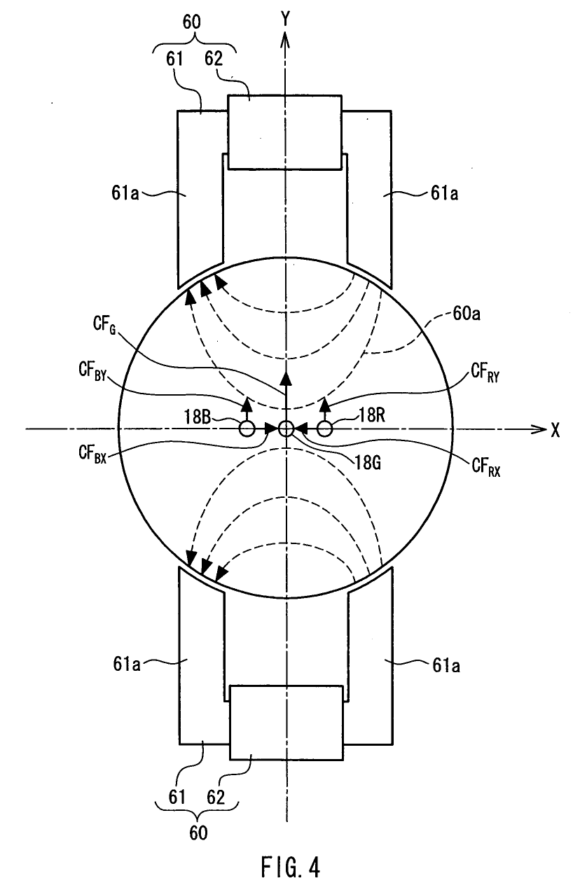

The deflection device 30 includes a pair of coma aberration correction coil systems (hereinafter, referred to as “correction coil systems”) 60 at positions on the electron gun 16 side from the vertical deflection coil 34 in the Z-axis direction. In the present embodiment, the pair of correction coil systems 60 are fixed onto the separator 38 at positions on the electron gun 16 side from the horizontal deflection coil 32 in the Z-axis direction. As shown in FIG. 4, the pair of correction coil systems 60 are disposed across the YZ-plane with the XZ-plane being interposed therebetween so as to be symmetrical with respect to the Z-axis. Each of the correction coil systems 60 includes a substantially U-shaped core 61 and a coil 62 wound at substantially the central position of the core 61. The substantially U-shaped core 61 is disposed such that the longitudinal direction of its two legs 61a is parallel to the Y-axis and the opening of the core 61 faces toward the XZ-plane. The tips of the legs 61a have an inclined surface that substantially follows the surface of a cylinder about the Z-axis.

The coil 62 is connected in series with the vertical deflection coil 34, and the same current as that is supplied to the vertical deflection coil 34 is supplied to the coil 62. Thus, as shown in FIG. 4, a pincushion preliminary vertical deflection magnetic field 60a is generated that has the same polarity as that of the barrel vertical deflection magnetic field 34a shown in FIG. 3. With the preliminary vertical deflection magnetic field 60a, the pair of correction coil systems 60 correct coma aberration (VCR) as described below.

The three electron beams 18R, 18G, 18B emitted from the electron gun 16 are deflected in a horizontal direction by the horizontal deflection magnetic field 32a shown in FIG. 2, and in a vertical direction by the preliminary vertical deflection magnetic field 60a shown in FIG. 4 and the vertical deflection magnetic field 34a shown in FIG. 3, and scan on the phosphor screen 14 by raster scanning. Furthermore, due to a non-uniform magnetic field formed by the horizontal deflection magnetic field 32a, the vertical deflection magnetic field 34a and the preliminary vertical deflection magnetic field 60a, the three electron beams 18R, 18G, 18B are converged over the entire surface of the phosphor screen 14.

A pair of magnetic members 70 are disposed across the YZ-plane between the vertical deflection coil 34 and the separator 38 with the XZ-plane being interposed therebetween so as to be symmetrical with respect to the Z-axis.

In the following, the action of the thus configured color cathode-ray tube apparatus according to this embodiment is described.

Following is a description of the action of the pair of permanent magnets TG, BG.

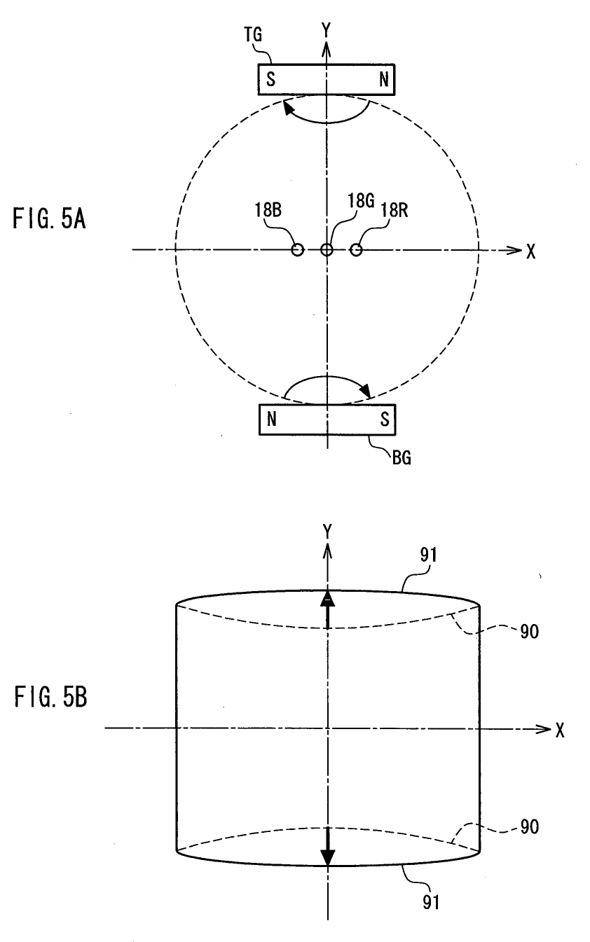

FIG. 5A is a front view showing the arrangement of magnetic poles of the pair of permanent magnets TG, BG seen from the phosphor screen 14 side and a magnetic field formed by this arrangement. As shown, the permanent magnets TG and BG are the same permanent magnets, and the positions and the directions of the magnetic poles thereof are symmetrical with respect to the Z-axis.

The permanent magnet TG (first magnetic field generator) placed on the upper side from the XZ-plane generates a magnetic field of the same polarity as that of a magnetic field generated by the vertical deflection coil 34 so that the three electron beams 18B, 18G, 18R are deflected to the upper side from the XZ-plane. The permanent magnet BG (second magnetic field generator) placed on the lower side from the XZ-plane generates a magnetic field of the same polarity as that generated by the vertical deflection coil 34 so that the three electron beams 18B, 18G, 18R are deflected to the lower side from the XZ-plane. That is, the pair of permanent magnets TG, BG generate a quadrupole magnetic field that attracts the three electron beams 18B, 18G, 18R, which are deflected to the vicinity of upper and lower ends on the Y-axis on the screen, to the upper and lower ends. Thus, as shown in FIG. 5B, the pair of permanent magnets TG, BG reduce pincushion raster distortion in upper and lower portions represented by dotted lines 90 to that represented by solid lines 91 (i.e., bring rasters in upper and lower portions close to a barrel shape).

Following is a description of the action of the pair of correction coil systems 60.

When the vertical deflection coil 34 generates the vertical deflection magnetic field 34a shown in FIG. 3 that deflects the three electron beams 18B, 18G, 18R to the upper side from the XZ-plane, the pair of correction coil systems 60 generate the preliminary vertical deflection magnetic field 60a that deflects the three electron beams 18B, 18G, 18R to the upper side from the XZ-plane as shown in FIG. 4.

Herein, since the preliminary vertical deflection magnetic field 60a is a pincushion quadrupole magnetic field as shown in FIG. 4, the preliminary vertical deflection magnetic field 60a does not have the same action on the three electron beams 18B, 18G, 18R.

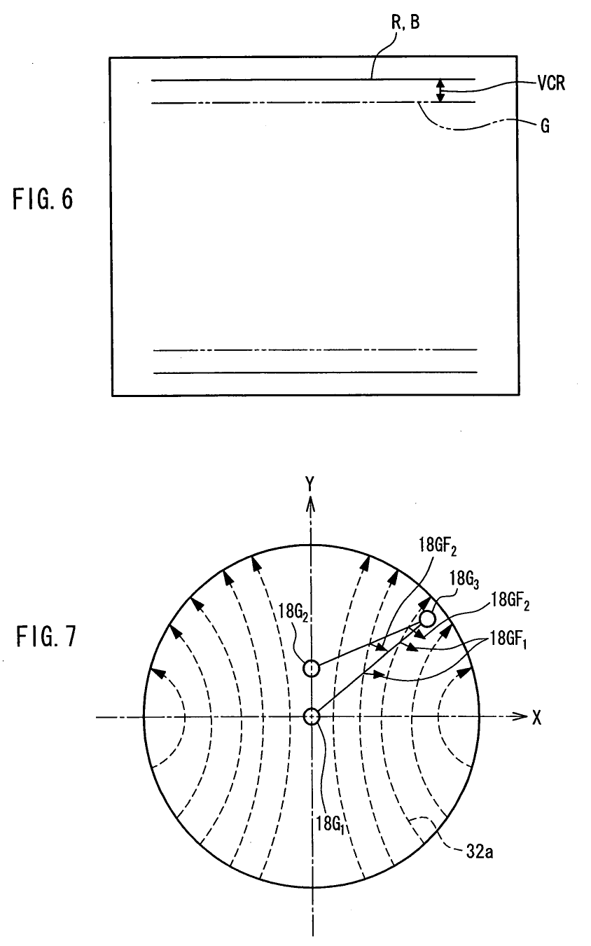

In the Y-axis direction, an upward deflecting force CF_{G} received by the center electron beam 18G is larger than upward deflecting forces CF_{BY}, CF_{RY} received by the side electron beams 18B, 18R. Accordingly, it is possible to correct a Y-axis direction displacement (misconvergence) of horizontal lines (rasters) Green G from the horizontal lines (rasters) Red R and Blue B in upper and lower portions of the screen shown in FIG. 6, that is, so-called coma aberration (VCR), which is generated by the barrel vertical deflection magnetic field 34a shown in FIG. 3.

In the X-axis direction, as shown in FIG. 4, the two side electron beams 18B, 18R receive inward deflecting forces CF_{BX}, CF_{RX} that cause the side electron beams 18B, 18R to approach the center electron beam 18G. Accordingly, the two side electron beams 18B, 18R are converged on the center electron beam 18G in the X-axis direction.

FIG. 7 is a conceptual diagram showing vectors of force that the center electron beam 18G traveling toward an upper right corner portion of the screen from the electron gun receives from the pincushion horizontal deflection magnetic field 32a, as seen from the phosphor screen side. In FIG. 7, 18G₂ indicates a position of the center electron beam 18G immediately before entering the region of the horizontal deflection magnetic field 32a when the center electron beam 18G has been subjected to preliminary vertical deflection by the preliminary vertical deflection magnetic field 60a before entering the region of the horizontal deflection magnetic field 32a. 18G₁ indicates a position of the center electron beam 18G immediately before entering the region of the horizontal deflection magnetic field 32a when the center electron beam 18G has not been subjected to preliminary vertical deflection by the preliminary vertical deflection magnetic field 60a before entering the region of the horizontal deflection magnetic field 32a. 18G₃ indicates a conceptual position of the center electron beam 18G immediately after exiting from the region of the horizontal deflection magnetic field 32a. As shown, the center electron beam 18G₂ that has been subjected to preliminary vertical deflection receives a force 18GF₂ from the horizontal deflection magnetic field 32a, and the center electron beam 18G₁ that has not been subjected to preliminary vertical deflection receives a force 18GF₁ from the horizontal deflection magnetic field 32a. Since the horizontal deflection magnetic field 32a has a pincushion shape, the inclination angle of the vector representing the force 18GF₂ with respect to the X-axis is larger than the inclination angle of the vector representing the force 18GF₁ with respect to the X-axis. Therefore, when preliminary vertical deflection is performed, rasters in upper and lower portions change to a barrel side, and rasters in left and right portions change to a pincushion side, as compared with when preliminary vertical deflection is not performed. Accordingly, the rasters in upper and lower portions change further to a barrel side and the rasters in left and right portions change further to a pincushion side with an increase in the amount of preliminary vertical deflection, that is, an increase in the strength of the preliminary vertical deflection magnetic field 60a generated by the pair of correction coil systems 60. Herein, the rasters in upper and lower (or left and right) portions “changing to a barrel side” refers to the following: the rasters in upper and lower (or left and right) portions change so that portions in the vicinity of the Y-axis (or the X-axis) of the rasters in upper and lower (or left and right) portions move away from the Z-axis, irrespective of whether the changed shape is a pincushion shape or a barrel shape. Furthermore, the rasters in upper and lower (or left and right) portions “changing to a pincushion side” refers to the following: the rasters in upper and lower (or left and right) portions change so that portions in the vicinity of the Y-axis (or the X-axis) of the rasters in upper and lower (or left and right) portions approach the Z-axis, irrespective of whether the changed shape is a pincushion shape or a barrel shape. Although only the center electron beam 18G is shown in FIG. 7 for the sake of simplicity of the description, the changes in the rasters in upper and lower portions and the rasters in left and right portions caused by the preliminary vertical deflection magnetic field 60a are the same for the two side electron beams 18B, 18R.

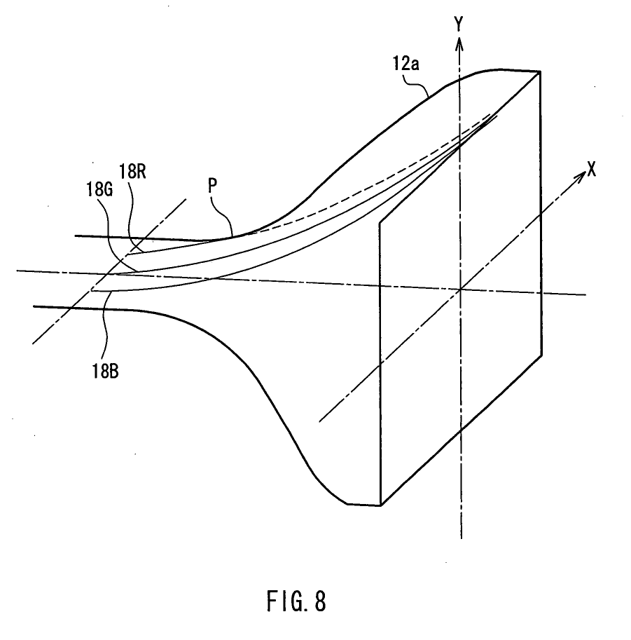

FIG. 8 shows how the side electron beam 18R strikes the point P on an inner surface 12a of the funnel in the vicinity of the neck and thus causes BSN, when the three electron beams 18B, 18G, 18R are deflected to a corner portion of the screen. When the amount of preliminary vertical deflection is increased as described above, one of the side electron beams 18B, 18R particularly tends to strike the inner surface 12a of the funnel, thus causing BSN.

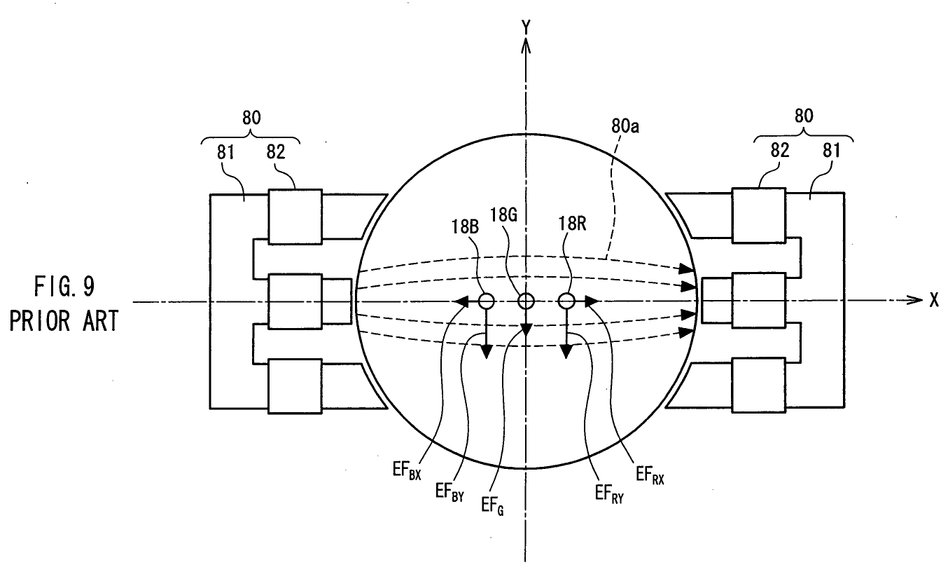

For comparison, following is a description of the action of a conventional pair of coma aberration correction coil systems that include a substantially E-shaped core and are disposed at positions on the electron gun side from the vertical deflection coil in the Z-axis direction. As shown in FIG. 9, correction coil systems 80 each include a substantially E-shaped core 81 and coils 82 that are respectively wound around three legs of the core 81. The pair of correction coil systems 80 are disposed across the XZ-plane with the YZ-plane being interposed therebetween so as to be symmetrical with respect to the Z-axis. The pair of correction coil systems 80 generate a coma aberration correction field 80a represented by broken lines in FIG. 9 when the vertical deflection coil 34 generates the vertical deflection magnetic field 34a shown in FIG. 3 that deflects the three electron beams 18B, 18G, 18R to the upper side from the XZ-plane. Unlike the preliminary vertical deflection magnetic field 60a shown in FIG. 4 that is generated by the pair of correction coil systems 60 including a substantially U-shaped core 61, the coma aberration correction field 80a has a polarity opposite to that of the vertical deflection magnetic field 34a, and has a barrel shape. In FIG. 9, EF_{BY}, EF_{G} and EF_{RY} indicate vectors of the Y-axis direction force components that the three electron beams 18B, 18G, 18R receive from the coma aberration correction field 80a, and EF_{BX} and EF_{RX} indicate vectors of the X-axis direction force components that the two side electron beams 18B, 18R receive from the coma aberration correction field 80a. Unlike the case of the pair of correction coil systems 60 including a substantially U-shaped core, with an increase in the strength of the coma aberration correction field 80a generated by the pair of correction coil systems 80, the amount of preliminary vertical deflection decreases, and the rasters in upper and lower portions change further to a pincushion side, and the rasters in left and right portions change further to a barrel side. Furthermore, the amount of preliminary vertical deflection decreases with an increase in the strength of the coma aberration correction field 80a, so that occurrence of BSN can be reduced.

From the foregoing, it is seen that the pair of coma aberration correction coil systems 80 including a substantially E-shaped core 81 is more suitable for correcting coma aberration, and pincushion distortion of rasters in left and right portions without degrading the BSN characteristics, than the pair of correction coil systems 60 including a substantially U-shaped core 61. However, the pair of coma aberration correction coil systems 80 including a substantially E-shaped core have a problem in that it is expensive.

Following is a description of the action of the pair of magnetic members 70.

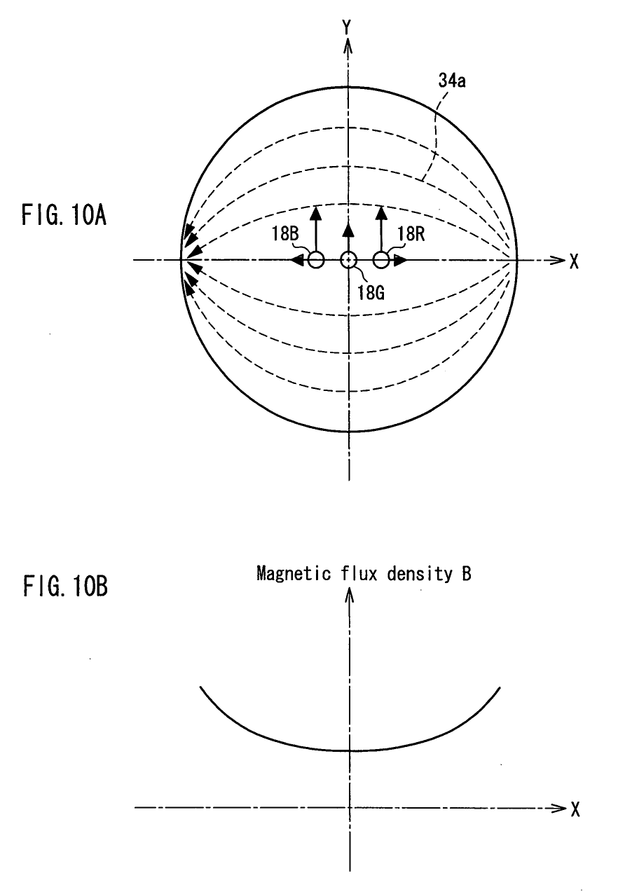

FIG. 10A is a view showing the vertical deflection magnetic field 34a changed by the pair of magnetic members 70 and vectors of force acting on the three electron beams 18B, 18G, 18R, and FIG. 10B is a view showing the magnetic flux density distribution of the vertical deflection magnetic field 34a along the X-axis in FIG. 10A. When the pair of magnetic members 70 are provided across the YZ-plane, the magnetic lines of force of the vertical deflection magnetic field 34a are changed such that they are drawn toward the pair of magnetic members 70 side, so that the barrel distortion of the vertical deflection magnetic field 34a is increased further. As a result, in the Y-axis direction, the deflecting force received by the side electron beams 18B, 18R is larger than the deflecting force received by the center electron beam 18G. Moreover, in the X-axis direction, the deflecting force received by the two side electron beams 18B, 18R that is directed to cause the side electron beams 18B, 18R to move away from the center electron beam 18G is larger. Accordingly, when the pair of magnetic members 70 are provided, one of the side electron beams 18B, 18R particularly tends to strike the inner surface 12a of the funnel, thus causing BSN.

Therefore, although it is possible to correct coma aberration, misconvergence, and pincushion distortion of rasters in upper and lower portions of the screen with a simple combination of the pair of correction coil systems including a substantially U-shaped core, the pair of magnetic members 70 and the pair of permanent magnets TG, BG, there is a new problem of degraded BSN characteristics.

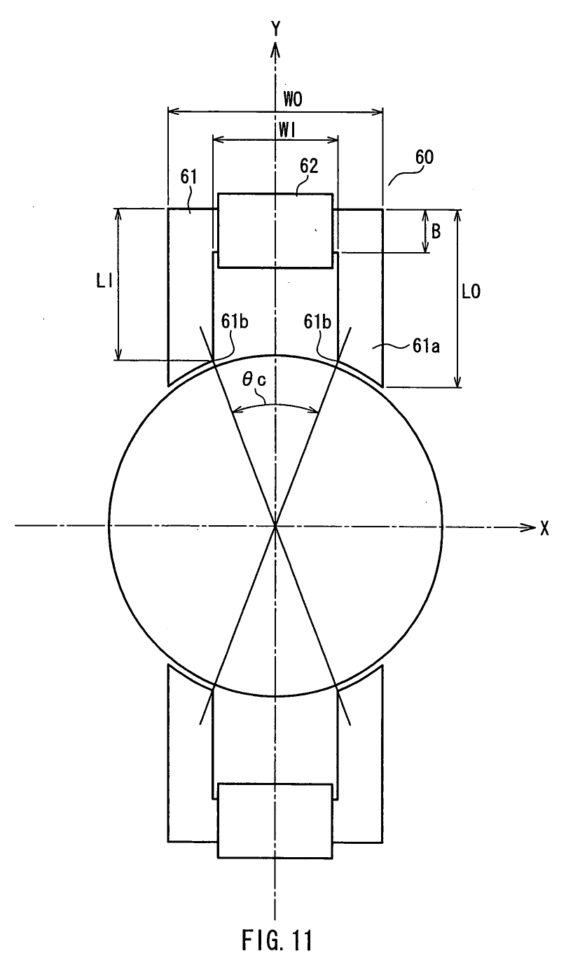

The present inventors focused their attention to the angle θc defined by inner tips 61b of the two legs 61a of the substantially U-shaped core 61 of each of the pair of correction coil systems 60 and the Z-axis viewed along the Z-axis, and investigated the influence of the angle θc on the coma aberration (VCR) correction amount and the BSN characteristics. Herein, as shown in FIG. 11, the angle θc is defined by the angle of the Z-axis side tips 61b of the inner surfaces of the two legs 61a of the substantially U-shaped core 61 and the Z-axis.

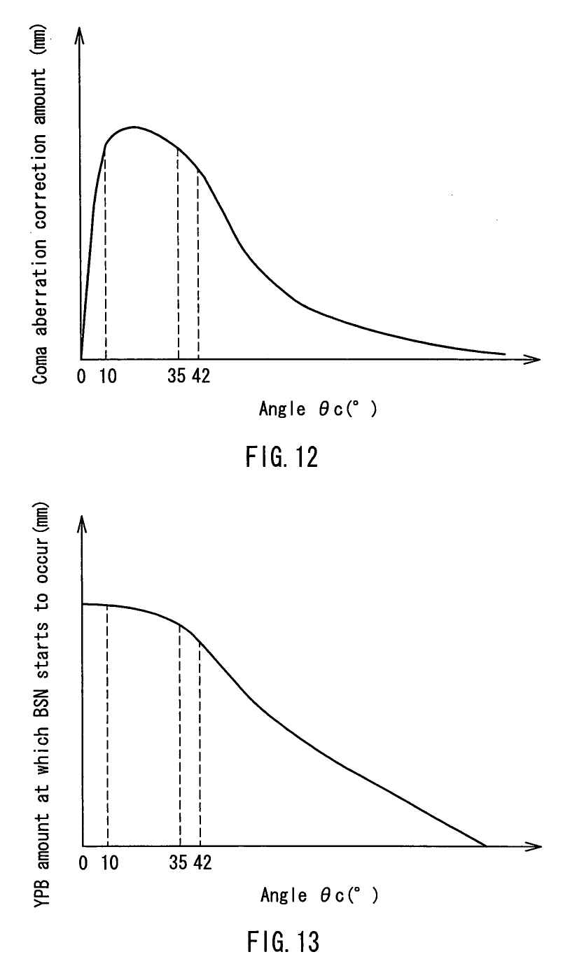

FIG. 12 is a graph showing a relationship between the angle θc of the pair of correction coil systems 60 including a substantially U-shaped core 61 and the coma aberration correction amount. In FIG. 12, the vertical axis denotes the amount of the coma aberration (VCR, see FIG. 6) that was able to be corrected by the pair of correction coil systems 60. Herein, the number of turns and the current value of the coils 62 of the correction coil systems 60 are constant. The angle θc of a conventional pair of correction coil systems 60 including a substantially U-shaped core 61 is 500 to 90°. When the angle θc falls below this, the coma aberration correction amount is increased. However, when the angle θc is further reduced, the coma aberration correction amount is decreased.

FIG. 13 is a graph showing a relationship between the angle θc of the pair of correction coil systems 60 including a substantially U-shaped core 61 and the YPB amount at which BSN starts to occur. In FIG. 13, the YPB amount at which BSN starts to occur, which is plotted on the vertical axis, was determined as follows. The deflection device 30 on which the pair of correction coil systems 60 were mounted was inserted onto the funnel 12 from the neck 13 side until it hit the funnel 12. From this state, the deflection device 30 was moved in the Z-axis direction away from the panel 11. When the movement amount exceeded a certain value, BSN occurred. The Z-axis direction distance from the position at which the deflection device 30 hit the funnel 12 to the position of the deflection device 30 at which BSN started to occur was determined as the YPB (Yoke Pull Back) amount.

The YPB amount at which BSN starts to occur increases with a decrease in the angle θc, and the slope of the curve of the YPB amount is gentle in the range in which the angle θc is smaller than 42°. The reason is as follows. When the angle θc is decreased, the Y-axis direction forces CF_{BY}, CF_{G}, CF_{RY} acting on the three electron beams 18B, 18G, 18R, which are shown in FIG. 4, are decreased together. Moreover, at this time, the degree of decrease of the Y-axis direction forces CF_{BY}, CF_{RY}, which have a significant influence on the BSN characteristics, acting on the side electron beams 18B, 18R is greater than the degree of decrease of the Y-axis direction force CF_{G}, which has a less significant influence on the BSN characteristics, acting on the center electron beam 18G. At the same time, when the angle θc is decreased, the X-axis direction converging force CF_{BX}, CF_{RX} acting on the two side electron beams 18B, 18R is increased. However, when the angle θc is further decreased, the absolute value of the magnetic force acting on the three electron beams 18B, 18G, 18R is reduced, so that the X-axis direction converging forces CF_{BX}, CF_{RX} acting on the two side electron beams 18B, 18R is decreased. Accordingly, with a synergistic effect of these, as the angle θc is decreased, the distance between the side electron beam (18B or 18R) and the inner surface 12a of the funnel (see FIG. 8) when the three electron beams 18B, 18G, 18R are deflected to a corner portion of the screen is increased, thus improving the BSN characteristics. When the angle θc is further decreased, the degree of increase of the distance between the side electron beam (18B or 18R) and the inner surface 12a of the funnel 12 is reduced. Therefore, the YPB amount at which BSN starts to occur is the largest in the range in which the angle θc is smaller than 42°.

From FIGS. 12 and 13 described above, the angle θc preferably satisfies 10°≦θc≦42°, and more preferably satisfies 10°≦θc≦35° in order to secure the coma aberration correction amount and to prevent occurrence of BSN at the same time.

In general, the YPB amount is preferably as large as possible. In the production of the color cathode-ray tube apparatus, convergence variations resulting from tilting of the deflection device 30 with respect to the tube axis of the color cathode-ray tube 10, or positional displacement of the deflection device 30 in the X-axis direction and the Y-axis direction can be corrected by inserting a correction piece between the deflection device 30 and the funnel 12. In order to reserve a gap into which this correction piece is inserted between the deflection device 30 and the funnel 12, it is necessary to secure about 2.5 mm as the YPB amount. Furthermore, in consideration of variations in the funnel 12, the deflection device 30 and so on, it is necessary to add a margin of at least about 2.5 mm to the minimum YPB amount at which BSN does not occur in design. As such, in general, the YPB amount is preferably at least about 5 mm.

The experimental results will be shown, in the case of applying the present invention to a 51-cm color cathode-ray tube apparatus with a deflection angle of 90° (hereinafter, referred to as an “example”).

The color cathode-ray tube apparatus of the present example had the configuration as shown in FIG. 1.

As the pair of permanent magnets TG, BG, permanent magnets with a magnetic force of 3.5 mT in the shape of a rectangular parallelepiped were used, which had a dimension in the X-axis direction of 51 mm, a dimension in the Y-axis direction of 10 mm, and a dimension in the Z-axis direction of 11.5 mm. A Y-axis direction distance TBLY from the outermost peripheral edge of the core 36 on the large-diameter side to the pair of permanent magnets TG, BG was set to be 6 mm, and a Z-axis direction distance TBLZ from the end of the core 36 on the large-diameter side to the center of the pair of permanent magnets TG, BG was set to be 5 mm. A Z-axis direction distance D1 from the reference line RL to the center of the pair of permanent magnets TG, BG was 10 mm. Herein, the “reference line RL” refers to a virtual reference line perpendicular to the Z-axis, and the position of the reference line RL on the Z-axis is matched with a geometric deflection center position of the cathode-ray tube. The magnetic poles of the pair of permanent magnets TG, BG were arranged as shown in FIG. 5A.

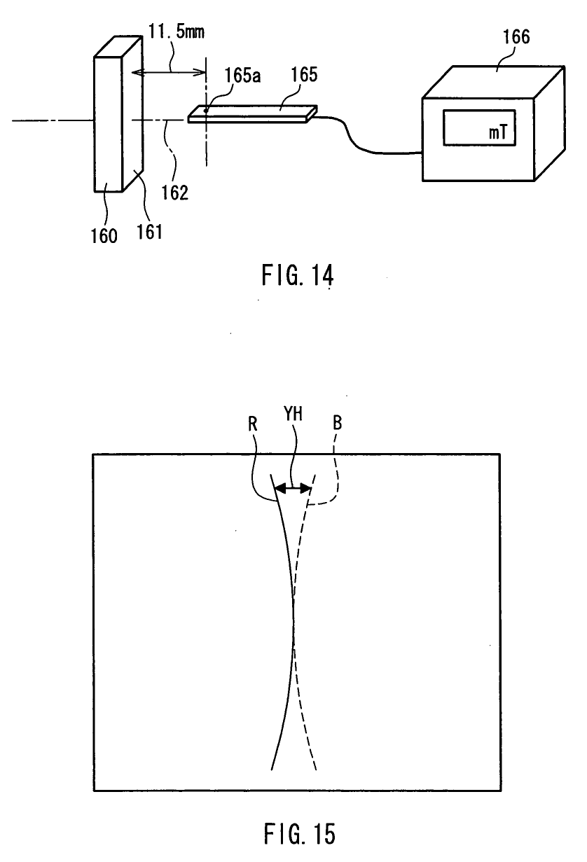

A method for measuring the above-mentioned magnetic force (magnetic flux density) of the pair of permanent magnets TG, BG will be described with reference to FIG. 14. A magnetic field measurement probe 165 was set so as to be opposed to an end face 161 of a permanent magnet 160 to be measured. At this time, a measurement point 165a of the probe 165 was placed on a normal line 162 set up at a center point of the end face 161, and the distance from the end face 161 to the measurement point 165a was set to be 11.5 mm. Herein, the end face 161 was set to be a plane opposed to the Z-axis when the permanent magnet 160 was mounted on the deflection device 30. Thus, a magnetic flux density at the measurement point 165a was obtained by an arithmetic operation device 166, and was determined to be the magnetic force of the permanent magnet 160. The measurement was conducted at an ambient temperature of 25° C.

In FIG. 11, an X-axis direction outer dimension WO of the substantially U-shaped core 61 of each of the pair of correction coil systems 60 was set to be 18 mm, a space WI between the legs 61a was set to be 7.5 mm, a Y-axis direction dimension LO of the core 61 along the outer surface of the legs 61a was set to be 23 mm, a Y-axis direction dimension LI of the core 61 along the inner surface of the legs 61a was set to be 21 mm, and an Y-axis direction width B of the bottom of the core 61 around which the coil 62 was wound was set to be 7 mm. An angle θc defined by the inner tips 61b of the two legs 61a and the Z-axis viewed along the Z-axis was set to be 23.5°. The coil 62 was formed by winding 125 turns of wire around the above-described substantially U-shaped core 61.

A Z-axis direction length of the ferrite core 36 was 37 mm.

A Z-axis direction length Liv of the magnetic member 70 was set to be 10 mm, a distance Livg from the end of the vertical deflection coil 34 on the electron gun 16 side to the end of the magnetic member 70 on the electron gun 16 side was set to be 4 mm, and a distance Livs from the end of the vertical deflection coil 34 on the electron gun 16 side to the end of the magnetic member 70 on the phosphor screen 14 side was set to be 6 mm. A Z-axis direction dimension Lv of the vertical deflection coil 34 was set to be 38 mm.

In the present example, pincushion distortion of rasters in upper and lower portions was +0.1%, and pincushion distortion of rasters in left and right portions was +0.2%, and both of these were satisfactorily within ±0.5%, which was a desired range for pincushion distortion of rasters. The coma aberration VCR (see FIG. 6) was −0.05 mm, and was satisfactorily within ±0.2 mm, which was a desired range.

As described with reference to FIG. 4, by the action of the pincushion magnetic field distortion formed by the pair of correction coil systems 60, the side electron beams 18B, 18R receive the deflecting forces CF_{BX}, CF_{RX} that converge the side electron beams 18B, 18R on the center electron beam 18G side. Accordingly, as shown in FIG. 15, the pair of correction coil systems 60 cause an X-axis direction misconvergence called “YH”, in which the vertical line of Red R is displaced to the left side and the vertical line of Blue B is displaced to the right side, in upper and lower portion of the screen. However, the vertical deflection magnetic field 34a has a barrel magnetic field distortion as shown in FIG. 3, and the pair of magnetic members 70 disposed on the Z-axis side from the vertical deflection coil 34 acts to increase the barrel magnetic field distortion of the vertical deflection magnetic field 34a as shown in FIG. 10A. This barrel magnetic field distortion of the vertical deflection magnetic field 34a has the diverging action that moves the side electron beams 18B, 18R away from the center electron beam 18G. This cancels the YH misconvergence shown in FIG. 15 caused by the pair of correction coil systems 60. In the example, the YH misconvergence was −0.2 mm. Moreover, various other convergence characteristics were within desired ranges.

Furthermore, in the example, the YPB amount at which BSN starts to occur was 5.2 mm, and was satisfactorily more than 5.0 mm, which was a desired range.

As described above, all of the coma aberration VCR, the misconvergence, and the pincushion distortion of rasters in upper, lower, left and right portions of the color cathode-ray tube apparatus of the example were reduced, and its BSN characteristics were also at a satisfactory level.

The pair of magnetic members 70 also acts to weaken the preliminary vertical deflection. Accordingly, when a protrusion amount of the pair of magnetic members 70 from the end of the vertical deflection coil 34 on the electron gun 16 side toward the electron gun 16 side in the Z-axis direction is increased, the effect of reducing the preliminary deflection is increased, so that it is possible to improve the BSN characteristics and also to reduce the pincushion distortion of rasters in left and right portions. However, when the above-described protrusion amount is increased too much, it is necessary to move the pair of correction coil systems 60 to the electron gun 16 side in the Z-axis direction. However, with an increase in the amount in which the pair of correction coil systems 60 are moved to the electron gun 16 side, the preliminary vertical deflecting action by the pair of correction coil systems 60 is increased, thus degrading the BSN characteristics. Accordingly, as a whole, it is preferable that the above-described protrusion amount of the pair of magnetic members 70, that is, the Z-axis direction distance Livg from the end of the vertical deflection coil 34 on the electron gun 16 side to the end of the pair of magnetic members 70 on the electron gun 16 side is at least 2 mm and at most 6 mm.

When the pair of magnetic members 70 are disposed in the vicinity of the center of the vertical deflection coil 34 in the Z-axis direction or at a position closer to the phosphor screen 14 side therefrom, the pincushion distortion of rasters in upper and lower portions, and rasters in left and right portions is increased. Therefore, it is preferable that the Z-axis direction distance Livs between the end of the pair of magnetic members 70 on the phosphor screen 14 side and the end of the vertical deflection coil 34 on the electron gun 16 side, and the Z-axis direction length Lv of the vertical deflection coil 34 satisfy 0≦Livs≦0.5×Lv.

The vertical deflection magnetic field generated by the vertical deflection coil 34 is the strongest in the region in the vicinity of the center of the vertical deflection coil 34 in the Z-axis direction, and this region has the most significant influence on the increase of the pincushion distortion of rasters in left and right portions. Therefore, a pair of magnetic members also may be disposed on each of the electron gun 16 side and the phosphor screen 14 side from this region, and not in this region. In this case, it is preferable that the pair of magnetic members (first magnetic members) disposed on the electron gun 16 side is located such that the Z-axis direction distance Livs between the end of the pair of first magnetic members on the phosphor screen 14 side and the end of the vertical deflection coil 34 on the electron gun 16 side, and the Z-axis direction length Lv of the vertical deflection coil 34 satisfy 0≦Livs≦(⅓)×Lv. On the other hand, it is preferable that the pair of magnetic member (second magnetic members) 72 disposed on the phosphor screen 14 side is located in an area that is at least (⅔)×Lv away from and at most Lv away from the end of the vertical deflection coil 34 on the electron gun 16 side toward the phosphor screen 14 in the Z-axis direction.

Furthermore, at least one of the above-described pair of magnetic members 70, the pair of first magnetic members and the pair of second magnetic members 72 may be magnetic members having a polarity (e.g., permanent magnets), as long as they can achieve their purposes, namely, the effect of strengthening the barrel distortion of the vertical deflection magnetic field 34a and the effect of weakening the vertical deflection magnetic field.

The applicable field of the present invention is not particularly limited, and the present invention can be used in a wide range, for example, in a color cathode-ray tube apparatus for a television, a computer display, or the like for which high performance and low cost are required.

The above-described embodiments are merely intended to clarify the technical content of the present invention, and the invention should not be interpreted to only such specific examples. The present invention can be embodied with various modifications within the sprit of the invention and the scope of the claims, and should be interpreted broadly.

What is claimed is:

1. A color cathode ray tube apparatus comprising:
a color cathode-ray tube having an electron gun for emitting three electron beams aligned in a horizontal direction and a phosphor screen for emitting light when struck by the three electron beams emitted from the electron gun; and
a deflection device having a horizontal deflection coil for generating a horizontal deflection magnetic field that deflects the three electron beams in the horizontal direction, a vertical deflection coil for generating a vertical deflection magnetic field that deflects the three electron beams in a vertical direction, a ferrite core for enhancing a magnetic efficiency of the horizontal deflection coil and the vertical deflection coil, and a separator placed outside of the horizontal deflection coil and inside of the vertical deflection coil and the ferrite core,
wherein at least a pair of magnetic field generators are disposed in the vicinity of an end of the deflection device on the phosphor screen side with a horizontal plane being interposed therebetween, the horizontal plane including a horizontal axis and a tube axis,
the at least pair of magnetic field generators include a first magnetic field generator disposed on an upper side from the horizontal plane for generating a magnetic field of the same polarity as that of a magnetic field generated by the vertical deflection coil when the three electron beams are deflected upward, and a second magnetic field generator disposed on a lower side from the horizontal plane for generating a magnetic field of the same polarity as that of a magnetic field generated by the vertical deflection coil when the three electron beams are deflected downward,
a pair of coma aberration correction coil systems in each of which a coil is wound around a substantially U-shaped core are disposed on the electron gun side from the vertical deflection coil in a tube-axis direction with the horizontal plane being interposed therebetween so as to be symmetrical with respect to the tube axis,
a pair of magnetic members are disposed between the vertical deflection coil and the separator with the horizontal plane being interposed therebetween so as to be symmetrical with respect to the tube axis, and
an angle θc defined by inner tips of two legs of the substantially U-shaped core and the tube axis viewed along the tube axis satisfies 10°≦θc≦42°.

2. The color cathode-ray tube apparatus according to claim 1,
wherein at least a portion of the pair of magnetic members is located in an area between the pair of coma aberration correction coil systems and the vertical deflection coil in the tube-axis direction.

3. The color cathode-ray tube apparatus according to claim 1,
wherein a tube-axis direction distance from an end of the vertical deflection coil on the electron gun side to an end of the pair of magnetic members on the electron gun side is at least 2 mm and at most 6 mm.

4. The color cathode-ray tube apparatus according to claim 1,
wherein a tube-axis direction distance Livs between an end of the pair of magnetic members on the phosphor screen side and an end of the vertical deflection coil on the electron gun side, and a tube-axis direction length Lv of the vertical deflection coil satisfy 0≦Livs≦0.5×Lv.

5. The color cathode-ray tube apparatus according to claim 1,
wherein a tube-axis direction distance Livs between an end of the pair of magnetic members on the phosphor screen side and an end of the vertical deflection coil on the electron gun side, and a tube-axis direction length Lv of the vertical deflection coil satisfy 0≦Livs≦(⅓)×Lv,
a pair of second magnetic members are disposed between the vertical deflection coil and the separator with the horizontal plane being interposed therebetween so as to be symmetrical with respect to the tube axis, and
the pair of second magnetic members are located in an area that is at least (⅔)×Lv away from and at most Lv away from an end of the vertical deflection coil on the electron gun side toward the phosphor screen in the tube-axis direction.

6. The color cathode-ray tube apparatus according to claim 1,
wherein the magnetic members have a polarity.

7. The color cathode-ray tube apparatus according to claim 5,
wherein at least one of the pair of magnetic members and the pair of second magnetic members has a polarity.

8. The color cathode-ray tube apparatus according to claim 1,
wherein the angle θc satisfies 10°≦θc≦35°.

9. The color cathode-ray tube apparatus according to claim 1,
wherein the horizontal deflection coil is a saddle-type coil, and the vertical deflection coil is a toroidal coil.
